(19) United States
(12) Patent Application Publication
(10) Pub. No.: US 2013/0037382 A1
(43) Pub. Date: Feb. 14, 2013

(54) DEVICE FOR ORIENTING OBJECTS AND INSTALLATION COMPRISING SUCH A DEVICE

(71) Applicant: Pascal Murano, Octeville-sur-Mer (FR)

(72) Inventor: Pascal Murano, Octeville-sur-Mer (FR)

(73) Assignee: SIDEL PARTICIPATIONS, Octeville-Sur-Mer (FR)

(21) Appl. No.: 13/641,744

(22) PCT Filed: May 10, 2011
(86) PCT No.: PCT/FR2011/051050

§ 371 Date: Oct. 17, 2012

(30) Foreign Application Priority Data
May 11, 2010 (FR) 10 53669

(51) Int. Cl. B65G 47/244

(52) U.S. Cl. 198/379

(57) ABSTRACT

The invention relates notably to an installation comprising a device for orienting objects which have more or less two axes of symmetry and are placed on a conveyor. The installation is notable in that the device comprises four arms (81, 82, 83, 84) arranged perpendicular to one another so as to form a cross, the arms (81, 82, 83, 84) being mounted on a chassis, said chassis being mounted so that it can rotate about a common axis (Z) of rotation which is perpendicular to the plane of said conveyor. In addition, each arm (81, 82, 83, 84) is mounted with the ability to effect a rectilinear translational movement along a segment of a straight line, said segments being offset by a distance in relation to the common axis of rotation (Z), said segments intersecting to form a square centred on said common axis of rotation (Z). Finally, the installation comprises means for moving the axis (Z) of rotation of the device transversely with respect to the longitudinal axis (Z) of said conveyor of said items.

The invention relates to a device for orienting on a conveyor objects having substantially two axes of symmetry, and in particular an installation equipped with such a device.

“Objects having substantially two axes of symmetry” is understood to mean objects which can be oriented in two different ways. For example, these objects may be parallelepiped in shape, and be arranged so that either their large side is oriented in a given direction or their small side is oriented in said given direction. It may also mean batches of products that are substantially parallelepiped in shape, for example such as packs of milk or water bottles, or cases having two axes of symmetry, open or closed boxes with folded flaps forming the bottom of the box, etc.

Parallelepiped objects such as cardboard boxes sometimes need to be oriented in a certain way, for example when they arrive at a filling station.

Devices exist for orienting parallelepiped objects in conveyance installations.

Such devices generally fall into two categories.

The first category concerns devices which make use of a rotating belt that is driven to advance in the direction opposite the direction of conveyance and is placed at the edge of the conveyor so that it rotates the parallelepiped object that comes into contact with it. Document WO 92/18388 illustrates an example of such devices.

The second category concerns devices which make use of a pivoting arm that rotates the parallelepiped object when it presses against the arm. Documents EP 0 074 129 and EP 0 340 502 describe two examples of this type of device.

Each of the known devices has the disadvantage of being designed for one type of object to be oriented. In other words, each of the known devices can only orient one type of parallelepiped object because its dimensions are adapted to the parallelepiped object to be oriented, and it has a particular movement that is also specific to the object.

The invention relates to an installation comprising a device able to orient parallelepiped objects, said device being able to adapt to different shapes or dimensions of parallelepiped objects.

The invention therefore relates to an installation comprising a device for orienting objects which have substantially two axes of symmetry and are placed on a conveyor. Said installation is notable in that:

the device comprises four arms arranged perpendicularly to one another so as to form a cross, the arms being mounted on a chassis, said chassis being mounted so that it can rotate about a common axis of rotation which is perpendicular to the plane of said conveyor,

each arm is mounted with the ability to effect a rectilinear translational movement along a line segment, said segments being offset by a distance relative to the common axis of rotation, said segments intersecting to form a square centered on said common axis of rotation,

and the installation comprises means for moving the common axis of rotation of the device transversely relative to the longitudinal axis of said conveyor of said objects.

When implemented in this manner, the device comprised in the installation allows moving the arms to bring one of their ends closer to the axis of rotation or to move them away from said axis. The pattern formed by the arms can thus adapt to the dimensions of different parallelepiped objects. The device provides continuous object orientation, because of the cross arrangement of the arms and their rotational movement about a common vertical axis.

The installation of the invention may also comprise the following characteristics, individually or in any combination:
the installation comprises means for controlling a simultaneous movement of the arms along said segments in the counterclockwise or clockwise direction;
each arm is oriented at an angle of 45° relative to the direction of the line segment on which it is movably mounted;
the arms are adjustable by movement within a plane and each arm has a central end which can be moved along a line which forms an angle of 135° with the arm;
the arms comprise suction cups for maintaining the objects during their orientation;
the installation comprises a supply circuit for the suction cups which comprises:
   a compressed air supply;
   a rotary joint equipped with several outlets, each outlet supplying a distributor;
   each distributor supplying a block of suction cups attached to an arm;
   a control cam for each distributor, said cam being integrally attached to a frame;
   a venturi effect means associated with each block of suction cups;
the device is mounted on a structure forming a gantry straddling said conveyor;
the installation comprises means for spacing apart the objects to be oriented by a predetermined distance, and said predetermined distance is preferably equal to at least one and a half times the significant dimension of the box on the conveyor and, also preferably, the means for spacing apart the objects comprise several conveyors aligned one after another, each conveyor having a length and an advance speed such that the objects arrive in the vicinity of the orientation device spaced apart from each other by a spacing equal to at least half the significant dimension of the object on the conveyor;
said distance, referred to below as S, the segments are offset relative to the common axis of rotation satisfies the following formula:

$$S = ( \frac{L - W}{2} ) - \frac{e}{2}$$

where:
   L is the length of the parallelepiped object to be oriented,
   W is the width of the parallelepiped objet to be oriented, and
   e is the thickness of an arm of the device;
the arms are equipped with removable stop blocks, and preferably in this case said distance S satisfies the following formula:

$$S = ( \frac{L + 2 c - W}{2} ) - \frac{e}{2}$$

where:
   L is the length of the parallelepiped object to be oriented,
   W is the width of the parallelepiped objet to be oriented,
   e is the thickness of an arm of the device, and
   c is the width of said block;
the conveyor comprises means able to withstand the rotation of said objects without deformation, and preferably the conveyor comprises a belt having plate chains or modular open or closed mesh chains.

The invention also concerns the device made use of in the installation defined above for orienting objects which have substantially two axes of symmetry and are placed on a conveyor, the device being notable in that: it comprises four arms arranged perpendicularly to one another so as to form a cross, said arms being mounted on a chassis, said chassis being mounted so that it can rotate about a common axis of rotation which is perpendicular to the plane of said conveyor; each arm is mounted with the ability to effect a rectilinear translational movement along a line segment, said segments being offset by a distance relative to the common axis of rotation, said segments intersecting to form a square centered on said common axis of rotation.

The device of the invention may also comprise the following characteristics, individually or in any combination:
it comprises means for controlling a simultaneous movement of the arms along said segments (in the counterclockwise or clockwise direction);
the arms comprise suction cups for maintaining the objects during their orientation.

The invention is detailed in a sufficiently clear and complete manner in the following description to enable its execution. This is accompanied by drawings in which:

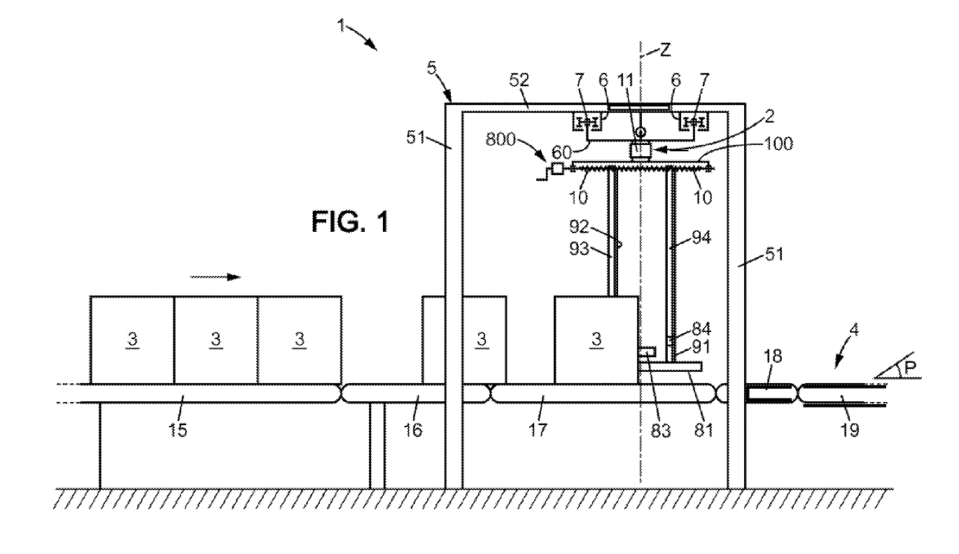

FIG. 1 shows an installation according to the invention, schematically represented in a front view;

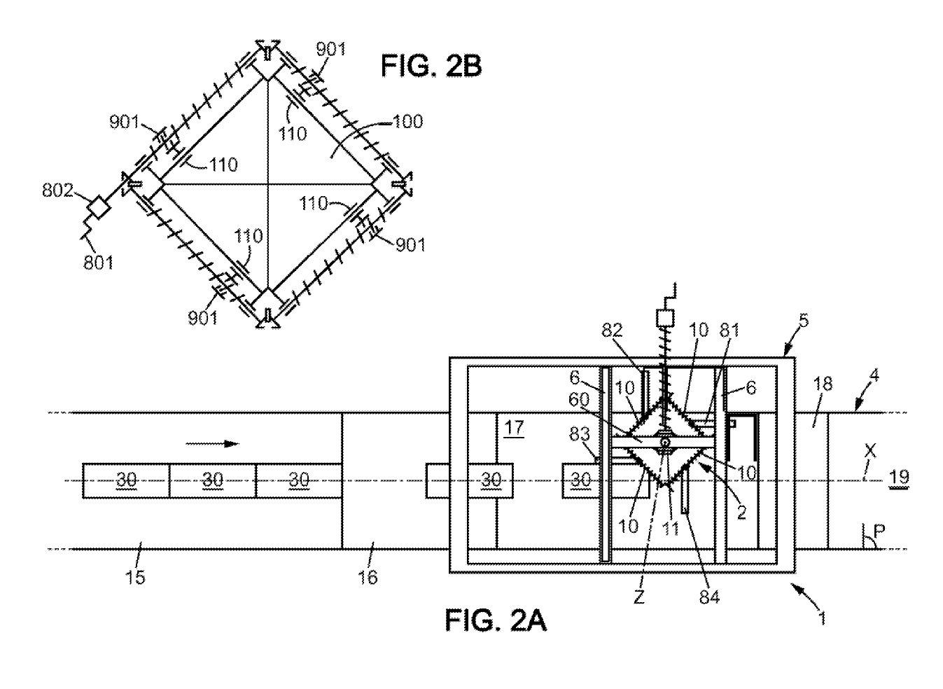

FIG. 2A shows a top view of the installation illustrated in FIG. 1;

FIG. 2B is an enlargement of a portion of FIG. 2A;

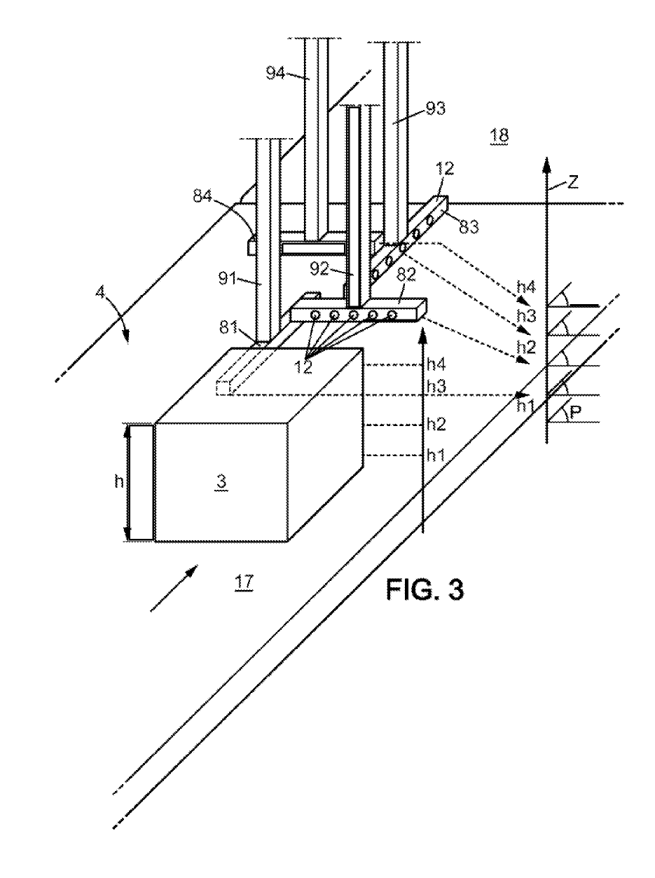

FIG. 3 illustrates a portion of the installation shown in FIGS. 1 and 2, in a profile view, and more specifically the arms placed at different levels above a conveyor;

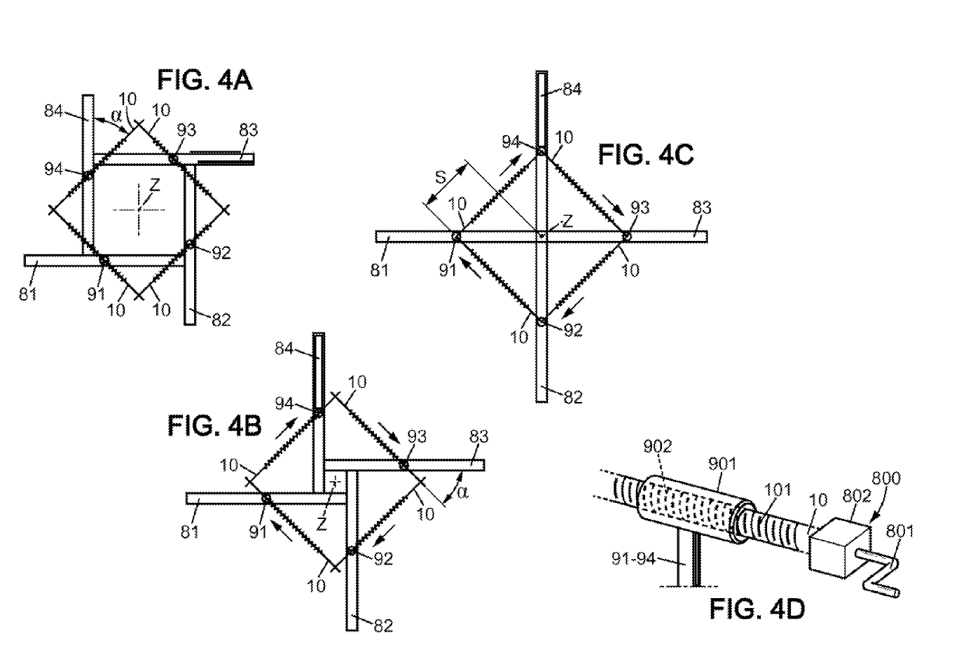

FIGS. 4a to 4c show the translational movements of the arms along line segments forming a parallelogram, between a position in which the arms are further apart from the common axis of rotation and a position in which they are as close as possible to the common axis of rotation;

FIG. 4d illustrates an embodiment of technical means allowing translational movement of the end of a vertical rod along a line segment;

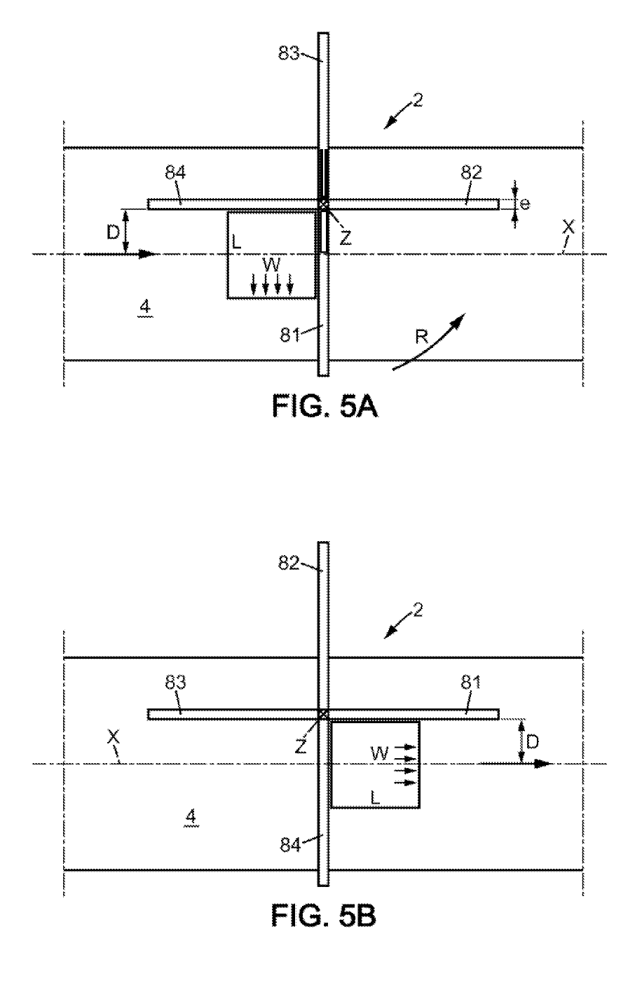

FIGS. 5A and 5B show the movement of the arms and the position of an object having a square cross-section, for two positions during the orientation of this object by the device, with the arms of the device being as close as possible to the axis of rotation;

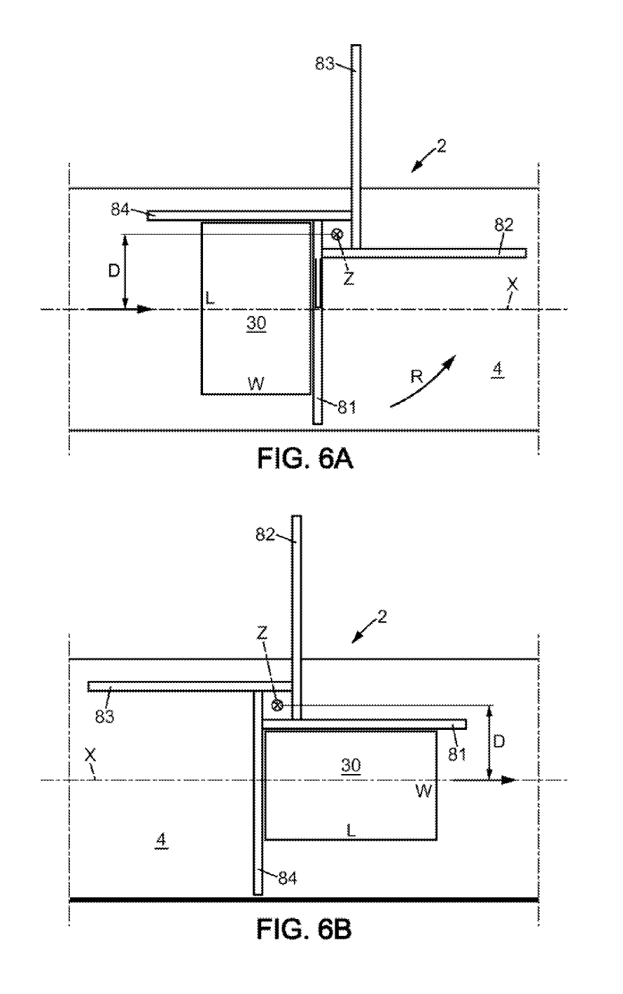

FIGS. 6A and 6B show the movement of the arms and the position of an object having a rectangular cross-section, for two positions during the orientation of this object by the device, with the arms of the device being distanced from the axis of rotation, the device being designed to orient boxes arriving transversely;

FIG. 6C shows a variant of the device shown in FIG. 6A with the arms of the device being distanced from the axis of rotation, the device being designed to orient boxes arriving longitudinally,

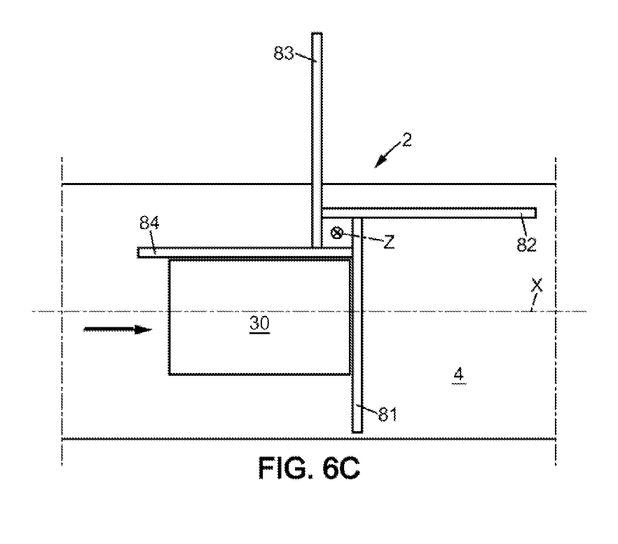

FIGS. 7A and 7B illustrate a device having arms equipped with stop blocks, showing the movement of the arms and the position of an object of rectangular cross-section having lateral flaps, for two positions during the orientation of this object by the device, the arms of the device being distanced from the axis of rotation;

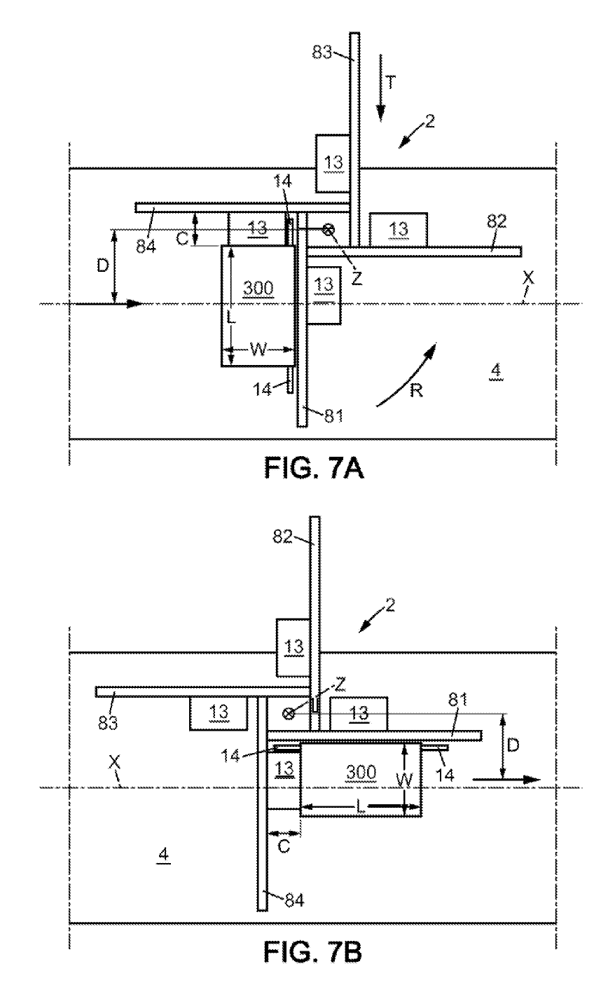

FIG. 8 illustrates a schematic side view of a portion of the installation of the invention, comprising a supply circuit for the suction cups which the arms of the device may have;

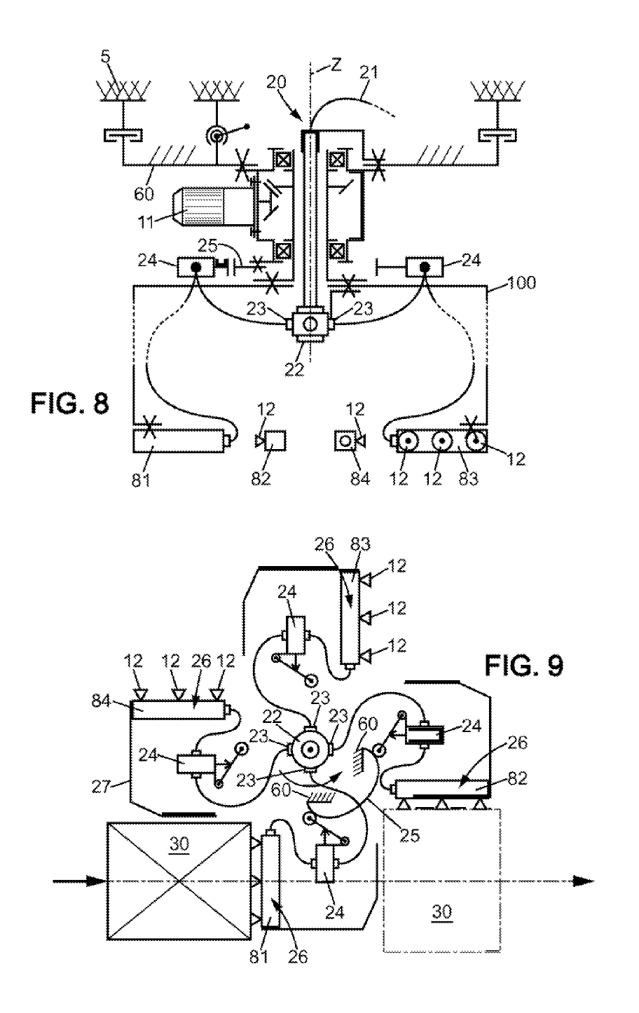

and FIG. 9 is a top view of a portion of the installation shown in FIG. 8.

FIGS. 1 and 2 show an installation 1 according to the invention, which comprises a device 2, also according to the invention, what is able to orient objects 3 or 30 on a conveyor 4 which is a group of several conveyors 15, 16, 17, 18 and 19 aligned in succession and defined below.

As can be seen in FIGS. 1 and 2, which show the installation from a side view and top view, the objects 3 and 30 have a parallelepiped shape which is respectively a cube or a rectangle.

The objects 30 are oriented on the conveyor 4 with their large sides parallel to the direction the conveyor 4 is advancing (direction of travel indicated by an arrow).

The device 2 which orients the objects 3 or 30 placed on the conveyor 4 is mounted onto a gantry structure 5 straddling the conveyor 4.

The structure 5 ensures that the device is well balanced above the conveyor 4, due to the four feet 51 distributed on each side of the conveyor 4.

In the upper portion 52, the structure 5 has guide rails 6 arranged transversely to the conveyor 4 and extending to each side of the gantry.

Each of these guide rails 6 houses a ball bearing guide system 7 (see FIG. 1) that can move within the rails 6. Each of the ball bearing guide systems 7 is connected to the ends of a bar 60 to which the device 2 of the invention is attached.

Thus the installation 1 of the invention comprises means allowing transverse displacement of the device 2 relative to the axis Z of the conveyor 4, these means comprising ball bearing guide systems 7 which are attached to the ends of the bar 60 and are free to move within the rails 6.

As can be seen in particular in FIGS. 1 and 2, the device 2 of the invention comprises four arms 81, 82, 83 and 84, which are arranged perpendicularly to one another so as to form a cross (also see FIGS. 4a, 4b and 4c).

The arms 81 to 84 are mounted to rotate as one unit about a common axis Z of rotation which is perpendicular to the plane P of the conveyor 4.

To do this, the arms 81 to 84 are respectively attached to the ends of vertical rods 91 to 94, meaning said rods are perpendicular to the plane P of the conveyor 4.

The other end of the vertical rods 91 to 94 is movably mounted on a rectilinear element 10 forming a line segment.

The assembly formed by the arms 81 to 84, the segments 10, and the rods 91 to 94, is mounted on a chassis 100 which can be referred to as the “cross-supporting chassis”.

The chassis 100 is shown in more detail in FIG. 2B.

In particular, the chassis 100 is square in shape and supports the line segments 10 along its edges. The line segments 10 are connected at their ends by a bevel system.

The cross-supporting chassis 100 is assembled to rotate about the axis Z by means of a motor 11, as is shown in FIGS. 1 and 2A.

The line segments 10 to which each of the vertical rods 91 to 94 are attached intersect to form a square centered on the common axis Z of rotation (see FIGS. 4a, 4b and 4c).

Each of the arms 81 to 84, solidly attached to the respective vertical rods 91 to 94, is thus mounted with the ability to effect a rectilinear translational movement along a segment 10.

Each line segment 10 is offset by a distance S relative to the common axis Z of rotation.

In the context of this particular embodiment, this distance S satisfies the following formula:

$$S = ( \frac{L - W}{2} ) - \frac{e}{2}$$

where:
L is the length of the parallelepiped object 3 or 30 to be oriented;
W is the width of the parallelepiped object 3 or 30 to be oriented; and
e is the thickness of an arm of the device 2.

To ensure the translational movement of the arms 81 to 84 along the line segment 10, the installation comprises means 800 for controlling the movement of the arms. These means 800 constitute a common point of adjustment for each of the arms 81 to 84.

FIG. 1 shows a highly schematic representation of the control means 800.

More details can be seen in FIG. 4D. Said means may, for example, comprise a crank 801 and an associated meter 802, which together allow moving the arms 81 to 84 to specific positions on the line segments 10, these positions having been predetermined for particular objects.

It is understood that the control means 800 could be implemented in a different manner without leaving the scope of the invention. For example, the means 800 could be motorized.

To prevent any swaying motion of the vertical rods 91 to 94 supporting the arms, these rods are guided along the sides of the chassis 100 by guiding means 110.

As one can see in FIGS. 4a, 4b and 4c, the four arms 81 to 84 can change from a star configuration (see FIG. 4a) to a cross configuration (see FIG. 4c), by moving these arms 81 to 84 in a clockwise direction (see the arrows in FIGS. 4b and 4c).

To change from a cross configuration to a star configuration, actuating the crank 801 causes the arms 81 to 84 to move due to the translational displacement of the ends of the rods 91 to 94 in the clockwise direction along the line segments 10.

FIG. 4d shows an example of an embodiment which allows this translational movement: the line segments 10 comprise threading 101 along at least a portion of their length (the segments 10 may be realized as a worm screw) and the vertical rods 91 to 94 comprise a tubular portion 901 at their end, forming a T with the rod 91 and having an inner thread 902 which is complementary to the thread 101 of the line segments 10.

Rotating the line segments 10 therefore causes the tubular ends 901 of the vertical rods 91 to 94 to move, and as a result causes the arms 81 to 84 to move.

The rotation of the line segments 10 in one direction causes the arms 81 to 84 to move in one direction, and their rotation in the other direction therefore causes the translational movement of the arms 81 to 84 in the other direction.

The displacement of the arms occurs in a plane which is parallel to the plane P of the conveyor 4.

As can be seen in particular in FIGS. 4a and 4b, each arm 81 to 84 is oriented at an angle α of 45° relative to the direction of the line segment 10 on which it is movably mounted.

To allow the displacement of the arms 81 to 84 along the line segments 10, the arms are suspended above the conveyor 4 at different heights, as is particularly visible in FIG. 3.

If the arms 81 to 84 were all located in the same plane, their ends could not align with the axis Z of rotation. Thus, to allow the superposition of the ends of the arms 81 to 84, as in the cross configuration represented in FIG. 4c, the vertical rods 91 to 94 on which the arms are suspended have different lengths.

As shown in FIG. 3, the arm 81 closest to the conveyor is located at height h1 from the conveyor, and the second, third, and fourth arms 82 to 84 are located respectively at heights h2, h3 and h4 from the conveyor.

Note that height h4, which is the height furthest from the conveyor 17, is less than the height h of the object 3 shown in FIG. 3; otherwise the object 3 could not press against the arm 84.

Implemented in this manner, the arms 81 to 84 can form either a star (FIGS. 4a and 4b) or a cross (FIG. 4c), thus offering pairs of two support surfaces for an object 3 of a parallelepiped shape (a cube in the example shown in FIG. 3); the length by which an arm is supporting a side of the object 3 could thus be adjusted by changing the conformation assumed by the arms 81 to 84.

For the parallelepiped object 3 to arrive at the correct place between two successive arms, meaning that an angle of the parallelepiped object 3 fits into the angle formed by two arms 81 to 84, the device 2 can be moved transversely relative to the conveyor 4 by means of the ball bearing guide system 7 and the guide rails 6 provided in the structure 5.

One can therefore see that the axis Z of rotation of the device can also be moved transversely relative to the conveyor 4.

The device can thus be adapted not only to the dimensions of the objects 3 to be oriented, but also to the position of the objects 3 on the conveyor 4.

We will now focus more particularly on the device 2 of the invention and the installation 1 which comprises such a device, in order to present other characteristics of the invention that ensure optimum operation, meaning operation with little risk of malfunction.

First, as explained above, the objects 30 arriving on the conveyor 4 are initially oriented in a certain direction.

In the example illustrated in FIG. 6A, the object 30 is oriented transversely to the conveyor 4.

As it is advanced by the conveyor 4, the object 30 comes to nest between two consecutive arms, for example arms 81 and 84 of the device 2 of the invention (see FIG. 6a for example).

The arms 84 and 81 are rotated by the motor 11 around the axis Z (see arrow R in FIG. 6a), and the object 30 which has nested between arms 81 and 84 is reoriented after the 90° rotation of arms 81 and 84 about axis Z (see FIG. 6b).

The object 30, which had been transversely oriented relative to the conveyor 4, is now reoriented in a longitudinal direction as it is carried away.

In the same manner, the object 30 could initially arrive in a longitudinal orientation and then be reoriented to a transverse direction before it is carried away. FIG. 6c shows such an object arriving longitudinally on the conveyor before its reorientation.

As can be seen in FIGS. 5a and 5b, the device 2 of the invention also allows reorienting cubic objects 3 having a side W, for example on which is written a product reference or the content (the side W bearing the reference is indicated by a succession of aligned arrows).

In order to package the content of the object 3, it may be necessary to reorient it or orient it in a certain way on the conveyor 4.

Note in FIG. 5b that the reference placed on the object 3 is oriented in the direction of conveyance after the object 3 has been reoriented by the device 2 according to the invention.

FIGS. 7a and 7b show yet another embodiment of the device 2 of the invention.

In this embodiment, the device 2 comprises stop blocks 13 which are removably mounted on the arms 81 to 84. This embodiment has the particular function of reorienting boxes 300 having flaps 14, where the boxes 300 are conveyed on their sides on the conveyor 4.

As can be seen in FIG. 7a, one of the flaps 14 of the box 300 is inserted between an arm 81 and a stop block 13 attached to an adjacent arm 84, by translational movement T of the device 2 by means of the ball bearing guide system 7 and the guide rails 6 of the structure 5.

Once the flap 14 has been inserted between the block 13 and the arm 81, the device 2 is rotated R, such that arms 81 to 84 rotate 90° about the axis Z. The box 300 is thus reoriented on the conveyor 4 while still lying on its side.

The box 300 can then be filled from the side, downstream from the orientation device 2 of the invention.

In the context of this embodiment, the distance S, which is the distance the line segments 10 are offset relative to the common axis Z of rotation, satisfies the following formula:

$$S = ( \frac{L + 2 c - W}{2} ) - \frac{e}{2}$$

where:
L is the length of the parallelepiped object 300 to be oriented;
W is the width of the parallelepiped object 300 to be oriented;
e is the thickness of an arm of the device; and
c is the width of said stop block 13.

To prevent the objects 3, 30 or 300 being ejected off the conveyor 4 in the case where the arms 81 to 84 are moving at a high speed of rotation (ejection due to centrifugal force), the arms 81 to 84 may be equipped with suction cups 12 (see FIG. 3).

It should be noted that the presence of suction cups 12 is optional.

The suction cups 12 are associated with suction means (not represented) which generate a suction effect against the outer face of the object 3, 30 or 300 presented to them.

The suction means may be activated and deactivated by automation methods known to a person skilled in the art.

The presence of suction cups 12 may also be useful in cases where the shape of the object renders it unstable. One example is objects which have a much greater height than their length or width. Another example is objects, such as boxes, which are not completely filled. In such a case, the objects can become imbalanced during the rotation of the arms because their contents move due to the centrifugal force.

A supply circuit 20 supplies air to the suction cups 12, as shown in FIG. 8.

The circuit 20 comprises a compressed air supply 21: this is, for example, a pipe connected to a device which delivers compressed air (not represented) and a rotary joint 22.

The pipe is placed in the axis Z of rotation of the device of the invention.

The rotary joint 22 is a housing which comprises an inlet, connected to the pipe supplying the compressed air, and several outlets 23, each outlet 23 supplying a distributor with compressed air 24.

Each distributor 24 is connected to a block of suction cups 12, meaning an element which supports the suction cups 12 and which is connected to an arm 81, 82, 83 or 84.

Thus each distributor 24 supplies compressed air to a block of suction cups associated with an arm.

By known means, listed below, the supply of compressed air causes a slight negative pressure in the suction cups 12, which creates the desired suction effect needed to maintain the object to be reoriented.

To achieve this, the compressed air must only be supplied at certain times, in order to release the object once it is correctly oriented.

For controlling the suction effect of the suction cups 12, the circuit 20 is equipped with a control cam 25 for each distributor 24. The entry of compressed air into the distributor is enabled or disabled 24, depending on the position of the cam 25.

As can be seen in FIG. 8 or 9, said cam 25 is integrally attached to the frame 60.

Lastly, to ensure the suction effect at the suction cups 12 by injection of compressed air, venturi effect means 26 are associated with each block of suction cups 12. Such an operation which makes use of the venturi effect is described in the patent published under number FR 2 924 373.

FIG. 9 shows a portion of the device illustrated in FIG. 8, but rotated by 90° (clockwise) relative to the top view provided in FIG. 8.

It also shows that the object to be oriented first slides against the edge of an accepting dihedron (denoted 27) such that it is presented to the suction cups 12 of an arm (81, for example) in a manner that allows it to be captured by their suction.

We will now refer to FIGS. 1 and 2 in particular to present characteristics specific to the conveyor 4 of the installation 1 of the invention.

To allow continuous operation of the device 2 of the invention, meaning continuous rotation of the arms 81 to 84, the installation 1 comprises a conveyor 4 which is implemented as a succession of conveyers 15, 16, 17, 18 and 19 of different lengths and advance speeds.

In fact, in order to rotate the arms 81 to 84 continuously, it is necessary to provide means for spacing the objects 3, 30 or 300 sufficiently far apart from each other.

If the objects 3, 30 or 300 are not spaced sufficiently far apart, the rotation of the arms 81 to 84 could encounter interference or the objects 3, 30 or 300 could be damaged by the rotation of the arms 81 to 84.

The space left between the objects arriving in front of the device 2 must be equal to at least half the significant dimension of the object 3, 30 or 300 on the conveyor 4.

“Significant dimension” is understood to mean the length or width of the object 3, 30 or 300, depending on whether said object is placed longitudinally or transversely on the conveyor 4.

Thus the significant dimension of the object 3, 30 or 300 is equal to the dimension of the side of said object which is oriented longitudinally relative to the conveyor 4.

For example:
the significant dimension of the object 3 is equal to W or L (as the object 3 is a cube),
the significant dimension of the object 30 before reorientation is equal to w in the example illustrated in FIG. 6a, or is equal to L in the example illustrated in FIG. 2A, and
the significant dimension of the object 300 before reorientation is equal to w in the example illustrated in FIG. 7a.

Regardless of the dimension of the objects, the speeds of the conveyors are calculated as a function of the length of the arms.

The succession of conveyors, having different lengths and advance speeds, is therefore such that the oriented objects 3, 30 or 300 are spaced apart from each other by a distance called the “spacing distance” which is equal to at least one and a half times the significant dimension of said objects.

FIG. 1 shows the conveyor 4 which comprises the succession of conveyors 15, 16, 17, 18 and 19.

A first conveyor 15 has the function of bringing the objects 3, 30 or 300 towards the device 2 of the invention.

The conveyor 15 is an accumulation conveyor on which the objects 3, 30 or 300 are arranged single file and side by side.

A spacing conveyor 16 is provided just after the accumulation conveyor 15.

The spacing conveyor 16 advances at a speed that is greater than the speed of the accumulation conveyor 15. It also has a length substantially equal to at least one and a half times the significant dimension of the object 3, 30 or 300 (depending on the object to which the device 2 is applied) on the conveyor 4.

The spacing conveyor 16 is followed by a reinforced conveyor denoted 17.

The reinforced conveyor 17 advances at a speed greater than or equal to the speed of the spacing conveyor 16, and is of a length at least two and a half times the significant dimension of the object 3, 30 or 300 (depending on the object to which the device 2 is applied) on the conveyor.

The reinforced conveyor 17 is a conveyor designed to withstand the rotation of objects 3, 30 or 300 without any deformation.

In fact, the conveyor 17 which supports the objects 3, 30 or 300 during reorientation is subjected to deformations due to the friction of said objects at that time.

These are unwanted deformations because in the long term they could interfere with the object reorientation.

To ensure that the conveyor 17 is resistant to stresses from the objects 3, 30 or 300, it is equipped with a belt having plate chains or modular open or closed mesh chains.

The reinforced conveyor 17 may be followed by a safety conveyor 18 which advances at a greater speed than the speed of the reinforced conveyor 17 and is of a length substantially equal to at least the significant dimension of the object 3, 30 or 300 (depending on the object to which the device 2 is applied) on the conveyor 4.

This safety conveyor 18 is optional. It allows rapidly removing the object which has just been reoriented and prevents reoriented objects from piling up at the exit from the reorientation device 2, which would also lead to a malfunction of the device 2 of the invention.

Lastly, an outfeed conveyor 19 is provided after the safety conveyor 18. It advances at a lower speed than the safety conveyor 18.

The function of this outfeed conveyor 19 is to bring the reoriented objects 3, 30 or 300 to packaging stations located downstream from the device 2 of the invention.

The above description clearly explains how the invention allows reorienting parallelepiped objects which may have different dimensions and special characteristics, such as boxes with flaps for example.

In particular, one can easily understand from FIGS. 4a to 4c how the arms 81 to 84 are movably mounted on the line segments 10 forming a square.

One can also easily understand how, by using the transverse displacement means to move the device 2 (rails 6 and ball bearing guide system 7), the device 2 can be moved transversely to the conveyor 4.

This allows capturing objects 3, 30 or 300 placed at any distance from the edge of the conveyor 4, or objects which are located in the axis of the conveyor 4.

Because of this transverse displacement system, the width size requirements of the conveyor 4 are also easily reduced, because objects which arrive in the axis of the conveyor 4 are easily returned to the axis of the conveyor 4 afterwards.

It is understood that the exemplary embodiments presented above are not limiting, and that the invention extends to any equivalent implementations.

1-16. (canceled)

17. Installation comprising
a device for orienting objects which have substantially two axes of symmetry and are placed on a conveyor, said device comprising
four arms arranged perpendicularly to one another so as to form a cross, the arms being mounted on a chassis, said chassis being mounted so that said chassis can rotate about a common axis of rotation which is perpendicular to the plane of said conveyor,
wherein each arm is mounted with the ability to effect a rectilinear translational movement along a line segment, said segments being offset by a distance relative to the common axis of rotation, said segments intersecting to form a square centered on said common axis of rotation, and
means for moving said common axis of rotation transversely relative to the longitudinal axis of said conveyor of said objects.

18. Installation according to claim 17, comprising means for controlling a simultaneous movement of the arms along said segments.

19. Installation according to claim 17, wherein each arm is oriented at an angle of 45° relative to the direction of the line segment on which each arm is movably mounted.

20. Installation according to claim 17, wherein the arms are adjustable by movement within a plane which is parallel to the plane of the conveyor.

21. Installation according to claim 17, wherein the arms comprise suction cups for maintaining the objects during their orientation.

22. Installation according to claim 21, comprising a supply circuit for the suction cups which comprises:
a compressed air supply;
a rotary joint equipped with several outputs, each output supplying a distributor;
each distributor supplying a block of suction cups attached to an arm;
a control cam for each distributor, said cam being integrally attached to a frame;
venturi effect means associated with each block of suction cups.

23. Installation according to claim 17, comprising means for spacing apart the objects to be oriented, by a predetermined distance.

24. Installation according to claim 23, wherein said predetermined distance is equal to at least one and a half times the significant dimension of the object.

25. Installation according to claim 23, wherein the means for spacing apart the objects comprise at least two conveyors aligned one after another, each of said conveyors having a length and an advance speed such that the objects arrive in the vicinity of the orientation device spaced apart from each other by a distance equal to at least half the significant dimension of the object on the conveyor.

26. Installation according to claim 17, wherein said distance the segments are offset relative to the axis of rotation satisfies the following formula:
$$S = ( \frac{L - W}{2} ) - \frac{e}{2}$$
where:
L is the length of the parallelepiped object to be oriented;
W is the width of the parallelepiped object to be oriented; and
e is the thickness of an arm of the device.

27. Installation according to claim 17, wherein the arms are equipped with removable stop blocks.

28. Installation according to claim 27, wherein said distance the segments are offset relative to the axis of rotation, when stop blocks are present, satisfies the following formula:
$$S = ( \frac{L + 2 c - W}{2} ) - \frac{e}{2}$$
where:
L is the length of the parallelepiped object to be oriented;
W is the width of the parallelepiped object to be oriented;
e is the thickness of an arm of the device; and
c is the width of said stop block.

29. Installation according to claim 17, wherein said conveyor comprises at least one conveyance conveyor able to withstand the frictional stresses resulting from the rotation of said objects on its surface without any deformation.

30. Installation according to claim 29, wherein said conveyor comprises a belt having plate chains or modular open or closed mesh chains.

31. Device for orienting objects which have substantially two axes of symmetry and are placed on a conveyor, said device comprising four arms arranged perpendicularly to one another so as to form a cross, said arms being mounted on a chassis, said chassis being mounted so that said chassis can rotate about a common axis of rotation which is perpendicular to the plane of said conveyor,
wherein each arm is mounted with the ability to effect a rectilinear translational movement along a line segment, said segments being offset by a distance relative to the common axis of rotation, said segments intersecting to form a square centered on said common axis of rotation.

32. Device according to claim 31, wherein the arms comprise suction cups for maintaining objects during their orientation.
